(19) United States
(12) Patent Application Publication
(10) Pub. No.: US 2017/0004402 A1
(43) Pub. Date: Jan. 5, 2017

(54) PREDICTIVE RECOMMENDATION ENGINE

(71) Applicant: DIGITAL CAVALIER TECHNOLOGY SERVICES INC., Vancouver (CA)

(72) Inventors: Steve GRAHAM, Victoria (CA); Mike LALLY, Victoria (CA); Murray GALBRAITH, Shawnigan Lake (CA); Rob WYLIE, Victoria (CA)

(73) Assignee: DIGITAL CAVALIER TECHNOLOGY SERVICES INC., Vancouver (CA)

(21) Appl. No.: 14/755,016

(22) Filed: Jun. 30, 2015

(51) Int. Cl. G06N 5/04; G06N 7/00; G06F 17/30

(52) U.S. Cl. CPC G06N 5/04; G06F 17/30867; G06N 7/005

(57) ABSTRACT

The present invention provides a system and method for managing online content with a predictive recommendation comprising receiving a user request, the user request including at least one user criterion, generating a recommendation data packet based on the user request, sending the recommendation data packet to a recommendation algorithm module, the recommendation algorithm module comprising at least one recommendation algorithm and an analytics engine, retrieving at least one content recommendation from at least one content database, sending the at least one content recommendation to a results selection module, organizing the at least one content recommendation to generate a ranked content list, sending the ranked content list to the user.

### FIELD

The present invention relates to content management software. More specifically, the present invention relates to predictive recommendation engines for mass market websites.

### BACKGROUND

Current content management technologies for mass market web sites typically deliver the same content to each user as those users visit the site. Each user who arrives at the site sees the same content as every other user. Some sites may modify the presentation of this content based on specific rules, for example by geographic region, but this rules-based content personalization is limited and does not modify what content is delivered beyond broadly based groups.

Visitors to these web sites can become frustrated with the mass of content that is presented and find it difficult to find content that they are interested in. Rather than spend time browsing lengthy landing pages or searching the site for content relevant to specific topics of interest, visitors simply leave the site and go on to view other sites.

Revenue for publishers of web sites is largely dependent upon the traffic that the site generates. The larger the audience the site has and the more web pages that are viewed, the more money the site generates. If users become frustrated with finding relevant content and move off to other sites, the publishers forego the opportunity to generate revenue from that user.

U.S. Pat. No. 8,249,948 discloses a system in which 3^{rd} party recommendation algorithms are used to generate recommendations of items to purchase for web site visitors. The patent claims describe strategies for tracking performance of 3^{rd} recommendation algorithms, for selection, execution and integration of results from recommendations in response to a page request, for billing the web site owner for recommendations served and remitting portions of the invoiced amount to the recommendation algorithm owners.

However, this system is limited to E-commerce applications by its reliance on purchase event histories based on purchase actions and this limits its applicability to the digital publishing industry. This system is similarly limited in its applicability to other industries such as medical, agriculture and energy.

U.S. Pat. No. 8,504,583 discloses a system in which the contents of a web page viewed by a web site visitor is analyzed to identify its author. The system then retrieves other documents written by the same author, constructs a unique “entity I.D.” (Comprised of at least one of person, object, location, or topic) from this cluster of documents; associates this “entity I.D.” with other relevant web pages through web-site topology, historical search queries and links to other “entity I.D.s”. These relevant pages are then presented as recommendations to the web site visitor.

However, this system is limited to digital publishing use because of its reliance on content author metadata as well as web site topology and search query history and as such is of limited feasibility in other industries such as medical, agriculture and energy.

Accordingly, there is need for a real time, adaptive recommendation system that is driven primarily by content associations derived from analysis of user behaviour that is applicable to a broad range of sectors.

### BRIEF DESCRIPTION

The present invention provides an improved content management methods and system that can measure, predict, personalize and filter content in real-time to allow publishers to present content to users that they are more likely to be interested in and more likely to view.

In at least one embodiment, the present invention provides a predictive recommendation engine for managing online content having means for receiving a user request for recommended content, the user request including at least one user criterion, a algorithm selection module for receiving the user request from the means and generating a recommendation data packet based on the user request, a recommendation algorithm module in communication with the algorithm selection module and at least one content database, the recommendation algorithm module comprising at least one recommendation algorithm and an analytics engine, the recommendation algorithm adapted to retrieve at least one content recommendation from the least one content database based on the recommendation data packet a results selection module in communication with the algorithm selection module, the results selection module adapted to receive and store the at least one content recommendation, the results selection module adapted to sort the at least one content recommendation to generate a ranked content recommendation list, the results selection module adapted to forward the ranked content recommendation list to the algorithm selection module.

In at least one embodiment, the present invention provides a method of managing online content with a predictive recommendation having the steps of receiving a user request, the user request including at least one user criterion, generating a recommendation data packet based on the user request, sending the recommendation data packet to a recommendation algorithm module, the recommendation algorithm module comprising at least one recommendation algorithm and an analytics engine, retrieving at least one content recommendation from at least one content database, sending the at least one content recommendation to a results selection module, organizing the at least one content recommendation to generate a ranked content list and sending the ranked content list to a algorithm selection module.

### BRIEF DESCRIPTIONS OF THE FIGURES

These and other features of the invention will become more apparent in the following detailed description in which reference is made to the appended drawings, wherein:

FIG. 1 is a flow diagram illustrating one embodiment of a predictive recommendation engine in accordance with the present invention;

FIG. 2 is a flow diagram illustrating specific modules of the predictive recommendation engine illustrated in FIG. 1;

FIG. 3 is a flow diagram illustrating one embodiment of an algorithm selection module for use in connection with at least one embodiment of the present invention.

### DETAILED DESCRIPTION OF THE EMBODIMENTS

Providing recommended content that is consistent with the interests of individuals or groups at the time of viewing presents several challenges which are not adequately solved in the available prior art solutions. For example, the sub-second responsiveness required in numerous interactive applications is not accomplished in a scalable way that can be used across a wide variety of industrial applications. Further, the pursuit of speed and low computing power per request are generally inversely proportional with the need for quality results. To address these challenges the present predictive recommendation engine works in conjunction with pseudo-real-time recommendation algorithms and a series of deeper analytics to provide quality results while addressing execution time and computing restraints.

In at least one embodiment, the recommendation algorithms as defined herein constitute methods for calculating recommended content that may or may not exploit personal behavioural data. These algorithms may be dynamically constructed from metadata contained in a recommendation request (e.g. weightings for a weighted mean computation) or may be static algorithms (e.g. least squares or multidimensional polynomial curve fit).

In at least one embodiment, the present content recommendation engine can measure and predict content consumption and use this analysis to personalize and filter content in real-time in order to present content to users that are more likely to be interested in and more likely to view. In contrast to rules-based systems, the present invention provides a method that can analyze data for each individual and make personalized recommendations for that individual, rather than categorizing clients and visitors by group.

In at least one embodiment, the present invention proposes a solution for website owners that can result in visitors staying on the site longer, viewing more pages of content, purchasing more products, and/or returning to the site more often and thus generating more revenue for the publishers. In E-commerce applications, it is contemplated that the recommendation engine can increase conversion rates.

Other applications where the present invention can be utilized include, but are not limited to, online media providers, online advertising, emergency facility management, electrical generation and grid management, transportation management and video-based security, among other arrangements that will be readily understood by the skilled person.

In at least one embodiment the present recommendation engine can utilize JavaScript, an API (also known as a “Application Programming Interface”), and can work asynchronously with a web page, which means that content delivery is not delayed by the recommendation engine, however other arrangements that will be readily understood by the skilled person are also contemplated. The present recommendation engine does not require changing a website's “look and feel”. Further, it is contemplated that the present recommendation engine is web technology agnostic and can work with any known content management system and in other networking environments as will be readily understood by the skilled person.

It is contemplated that the present recommendation engine can also be used in a variety of industry verticals such as, but not limited to, energy, medical, security and other industries that generate large amounts of data (i.e. “Big Data”) that needs to be analyzed in real-time to provide useful results for the respective data owners.

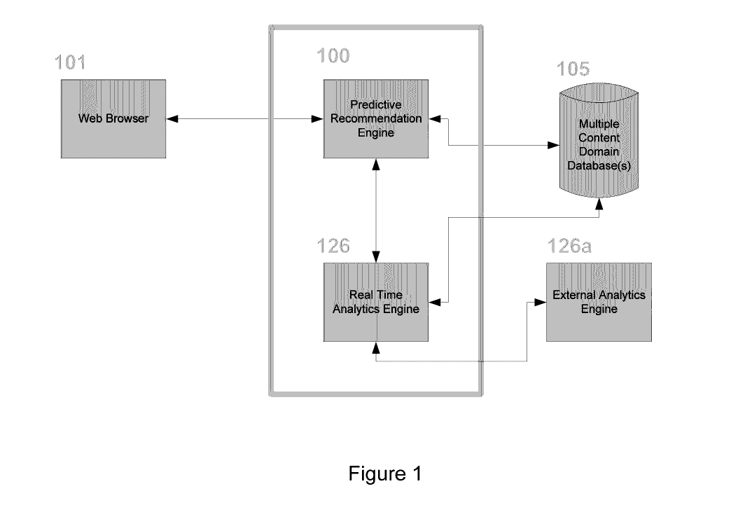

Turning to FIG. 1, at least one embodiment of the present invention is illustrated that provides a high level architecture of the parts that make up the present predictive recommendation engine (100). Predictive recommendation engine (100) can work with IP protocol based networks, however it is also contemplated that predictive recommendation engine (100) can work with other protocol based networks as well.

In at least one embodiment, data storage and retrieval can be accomplished using a persistent storage medium that can support one or many client domains associated with each client and one or many clients supported by the same software endpoint, which is referred to in the industry as a multi-tenant environment (i.e.: a single instance of the software running on a server, serving multiple client-organizations/tenants).

It is contemplated that the persistent storage can be handled in one or many databases depending on the needs of the present application, and will be referred to henceforth as the Multiple Content Domain Database(s) (105). Multiple Content Domain Database(s) (105) is used as needed to manage the persistent information required to build recommendations; examples of this include but are not limited to raw and processed behavioural data acquired by monitoring the activity of users and raw and processed metadata associated with web site content and service configuration data.

It is contemplated that the analytics engines (a) provide a facility for near-real-time reporting of statistics, (b) provide predictions of behavioral trends, (c) allow for integration of additional analytical resources (d) provide facilities for querying and updating data in the Multiple Content Domain Database(s), and (e) provide a facility for adjusting content weighting and scoring.

An internal Real Time Analytics Engine (126) and an External Analytics Engine (126a) can allow for both responsive provision of recommendations and deep analysis of data in order to adjust the weightings on individual content items and/or categories within the content taxonomy in Multiple Content Domain Database(s) (105) when needed. This approach to content weighting employs industry standard approaches for normalizing data, i.e. adjusting to a common scale, as will be readily understood by the skilled person.

In FIG. 1 a web browser (101) sends a request for recommendations to the predictive recommendation engine (100) via a client/browser network service request, such as an API call. This can contain (a) an identifier for the profile/user as detailed later in this document, (b) the name of the content domain which in the case of the network service request is a web domain, (c) the number of recommendations desired, and (d) optional filters that specify restrictions on recommendation results (categories, tags, content domains, time, etc. . . . ) with respect to the current content being viewed.

Based on the preferable (items a, b and c) and optional (item d) criteria specified in the data packet assembled from the client/browser network service request, requests for recommendations are made and multiple content domain database(s) (105) is queried for the additional data. The top recommendations are selected from personal data scored relative to the profile/user based on the identifier (a), either individual-specific or broader behavioural data generated from tracking the current site users, and the results are sent to web browser (101).

For example and referring again to FIG. 1, a user employs a web browser (101) to view selected content. Accompanying the selected content a set of recommendations relevant to the user's viewing habits is presented for consideration. The system may or may not present the user with a means of controlling attributes of the recommended content such as, but not limited to, date, topic, geographic location, web location. In operation the web browser (101) issues an API call to the predictive recommendation engine (100) via a client! browser network service request, and the recommendation engine (100) returns results to the web browser (101).

It is contemplated that the client/browser network service request can contain at least four pieces of information/data:
1) A unique user profile identifier. This may be unique to each user, or multiple users may be, in one example, given the same unique identifier. This allows the personalized predictive recommendation engine (100) to enable tailored recommendations at several levels—for example per visitor, per IP address group, per network, etc. The level of user profile (personal, network level, geography specific, etc. . . . ) is flexible and in at least one embodiment can be set by the operator of the personalized predictive recommendation engine (100);
2) The identity of the content domain which in the case of the browser network service request is a web domain, and is associated with data stored in multiple content domain database (105). In alternative embodiments of the invention the multiple content domain database can be a database managed by the web domain owner, multiple databases managed by the web domain owner, or multiple databases hosted and managed by various hosting providers, among other arrangements that will be readily understood by the skilled person;
3) The current content item being viewed b the user and
4) At least one unique behavioural identifier. The use of a data packet utilized by the personalized predictive recommendation engine (100) requires the API to provide at least one unique identifier to associate the current user's behaviour with that of other users' behaviours in the system. The unique behavioural identifier can be selected from various optional meta-data that can be used in the network service request, such as, but not limited to:
   a. Content selection history;
   b. Recommendation algorithm preference history;
   c. Recommendation count requested;
   d. Content restrictions of the recommendation, such as type, category, content owner, filters; and/or
   e. A specific set of algorithms that are mandatory.

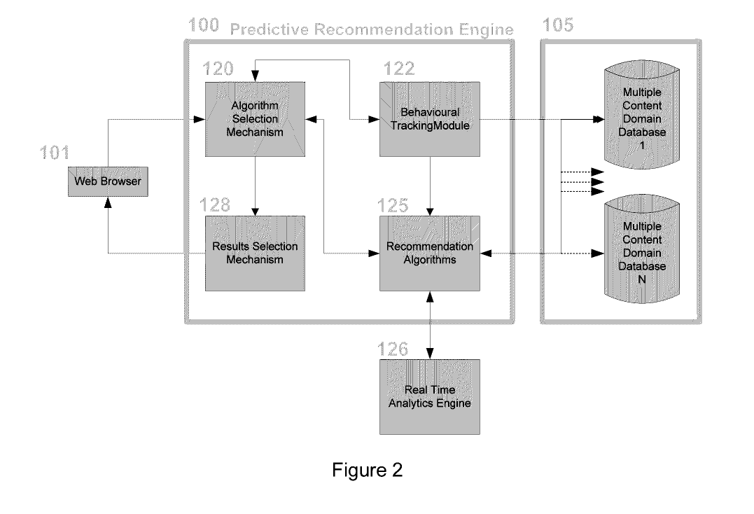

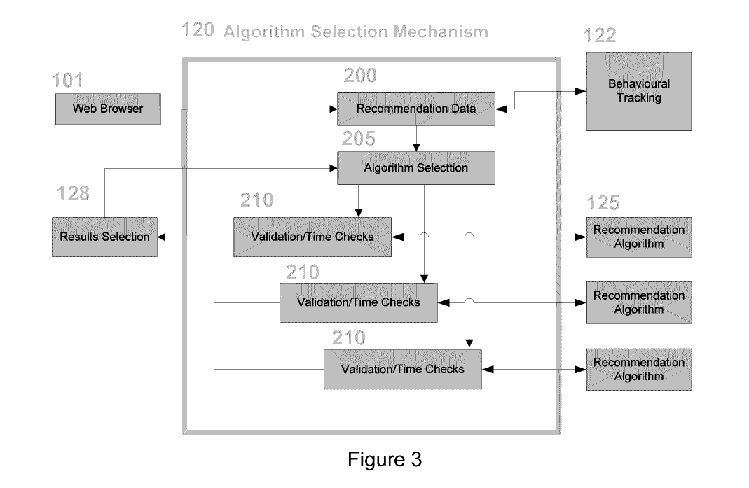

Turning to FIGS. 2 and 3 the algorithm selection module (120) receives recommendation requests via a network service request, which is used to build the recommendation data packet (200). Behavioural data is incorporated into the recommendation data packet by way of a request for personal data from behavioural tracking module (122), which returns behavioural data associated with the unique behavioural identifier in the network service request and for the tenant associated with the content domain(s) specified. This behavioral data also can include history on which algorithms have or have not previously provided recommendations to the current user as well as how frequently those recommendations were selected by the user.

Based on the personal data and the recommendation selection history, recommendation algorithms are ranked and the top ranked recommendation algorithms are selected (205), the process of which is known and uses standard approaches in the industry as will be readily understood by the skilled person. The recommendation algorithm selection may also include one or more recommendation algorithms that were not among the top ranked recommendation algorithms but are either broadly effective based on selection frequency across the user population or are particularly effective at recommending selected content from some part of the content taxonomy. Introducing these more generally successful recommendation algorithms can provide a mechanism of avoiding problems of over fitting.

The various recommendation algorithms (125) are executed asynchronously. If results from a particular recommendation algorithm execution don't meet the content requirements specified in the recommendation request and this is a first time failure with respect to the current request then the recommendation algorithm may be retried with parameters modified to restrict the results that were deemed incorrect. If the nature of the failure cannot be identified then the next highest ranked recommendation algorithm that has not yet been executed may be used.

Behavioural tracking module (122) is responsible for managing and providing access to individual or aggregated behavioural data. As content is viewed by users the behaviour tracking module is sent details on the activity including at least unique identifiers associated with the user, the content and the content domain, while optionally additional information may be included such as, but not limited to, taxonomic, date/time, geographic, among other information that will be readily understood by the skilled person.

The behavioural data is stored in multiple content domain database (105) and in some embodiments may also be maintained within the behavioural tracking module. Behaviour tracking module (122) also manages the recommendation history and algorithm performance history using the same mechanisms. This personal data can be used by both algorithm selection module (120) and recommendation algorithm module (125) to incorporate individual and group behaviour into the recommendations.

The recommendation algorithm module (125) consists of at least one recommendation algorithm (125) and in conjunction with analytics engine (126) provides the components from which the Algorithm Selection Module (120) dynamically builds a request specific recommendation analytics pipeline.

Recommendation algorithms (125) can consist of specific algorithms or algorithm templates plus data access and query building logic. Behavioural information from behavioural tracking module (122) is used for database (105) queries, for adjusting weightings used for recommendation scoring and for constructing specific algorithm instances from algorithm templates. Real Time Analytics engine (126) contains math libraries to be used in conjunction with the recommendation algorithms (125) and reporting functions. It also allows connectivity with external analytics engines (126a) for non-real-time traffic analysis.

As specific examples, suitable recommendation algorithms may include, but are not limited to, multidimensional polynomial curve fit algorithms, least squares, nearest neighbors with root square means filter, among other arrangements that will be readily understood by the skilled person.

It is contemplated that in some embodiments recommendation algorithms may be selected at least in part based on historical performance when recommending content deemed to be similar to the current web page where similarity between web pages may be determined either by meta-data tracking or through the use of some fast similarity scoring algorithm such as cosine similarity.

The results selection module (128) stores, sorts and filters the results of recommendation algorithms (125) as each set of results for a requested batch of recommendations is returned via the algorithm selection module (120). When all results have been received or a time-out condition has been met the sorted and filtered recommendations are returned to web browser (101).

As a complete example of the behavior of the system, in a particular embodiment, the recommendations might be provided on news websites. If a big “disaster” news story were to be published, it could be responsible for the majority of a news websites viewers coming to the site and algorithms which recommend this and related stories will do well. For visitors to the news site who have other, less popular interests and might stay to read more articles, if only the most viewed articles were returned as recommendations then “regional news” and “local sports” would be at a disadvantage. The Predictive Recommendation Engine could address the above scenario by noticing that, for example, a weighted mean algorithm had historically scored high overall within the content domain, has historically performed well when recommending content of interest to the particular user but consistently ranked below the algorithm selection threshold for several hours. By inclusion of the above mentioned algorithm but has been added to test whether a short success with a specific set of algorithms is forming a permanent exclusion of others due to their initial high rankings. If the algorithm produces recommendations that a user picks then the score for the user of this algorithm will increase and will become one of the preferred algorithms for the user. This impacts the overall score of the algorithm and it will improve its overall ranking in the content domain.

It will be appreciated that different recommendation algorithms (125) can produce different result sets of different sizes at different speeds, and as such a state model can be employed for time-based correction and response to failure states. Recommendation algorithms (125) can be executed together and as these algorithms are run the recommendation algorithm module (125) can introduce additional behavioral data from behavioral tracking module (122) to the algorithms in response to state changes.

The results received by the Results Selection Module (128) is variable in number, can be ranked, filtered and sorted in accordance with criteria provided in the request or retrieved from the database. As an example, if a recommendation request specifies that ten results be returned, the ten highest ranked recommendations are passed by the results selection module (128) to the browser (101) and a record of the associated recommendation algorithms is sent to behavioral tracking module (122) for storage in the multiple content domain database (105) for future use. Criteria may, but are not limited to date, category, recommendation score, and content domain.

Algorithm selection mechanism (120), real time analytics engine (126), and behavioural tracking module (122) can all communicate directly with recommendation algorithms (125). Behavioural tracking module (122) can be used with recommendation algorithms (125) and analytics engine (126). Algorithm selection mechanism (120) can select and execute individual recommendation algorithms (125) as illustrated in FIG. 3. Results selection module (128) cannot directly select or execute recommendation algorithms (125) but the algorithm selection mechanism may select and execute additional recommendation algorithms (125) based on results obtained from selection module (128).

Turning to FIG. 3, one embodiment of the internal process flow of algorithm selection module (120) is illustrated. Recommendation data (200) contains the details of the network service request for recommendations (such as, but not limited to, profile/user identifier, content domain name, number of recommendations requested, optional filters and details about the current content viewed), and also can combine behavioural data requested for the profile/user identifier from behavioural tracking module (122). Algorithm selection and execution (205) is the process whereby algorithms are chosen. Validation checks are the associated industry standard validation and error handling run against an asynchronous stream of recommendation algorithms (125), as will be readily appreciated by the skilled person.

In at least one embodiment, the process flow is contemplated as follows:
Recommendation data (200) is assembled from the network service request for recommendations and data received from behavioral tracking module (122);
Assembled recommendation data (200) is passed to the algorithm selection and execution process (205);
Asynchronous requests are made for the various recommendation algorithms (125)
Results returned by the recommendation algorithms (125) are run against validation checks (210) to verify that that they match any criteria that may be specified in the recommendation data (200);
Verified results, error reports or timeout reports are passed by the Validation mechanism (210) to the Results Selection Module (128).
If necessary and if time permits, the Results Selection Module (128) may request that the Algorithm Selection Module (205) select and execute additional recommendation algorithms (125);
Upon completion, a network service response outputs the results to the web browser (101).

Algorithm Selection Variables Embedded in Client/Browser Network Service Request

It is contemplated that in at least one embodiment the client/browser network service request can contain, but is not limited to, the following variables used by the algorithm selection:
Content Domains
If results are desired from multiple content domains then these content domains can be specified in the network service request. Alternatively, if the results are desired for all content domains for which the client is authorized then this can explicitly be specified. Finally, if results are omitted for particular domains based on predetermined limitations placed on the system then either results can be provided for the content domain for which any tracking details are recorded or alternatively a default configuration for the client specified in the multiple content domain database(s).
Recommendation Count
It is contemplated that a number of 0 or greater can be specified within the network services request, with the system configured for an upper limit to be used if the number is greater than this value (e.g. the hardware/software environment may only be able to handle up to 100 recommendations so this limit would then be configured in the system.
For example, if a value of 0 is specified then no recommendations are returned. This could also be handled by omitting this portion of the network service request. For another example, this could be employed when a network service request is used to track behaviour while a separate network service request is used to retrieve recommendations.
Algorithm Identification
This can in effect bypasses the identification process in the algorithm selection mechanism by specifying that a particular algorithm or set of algorithms within the network service request to be used for generating recommendations.

Algorithm Selection Variables Separate from Client/Browser Network Service Request

Further, it is contemplated that in at least one embodiment the algorithm selection can optionally use, but is not limited to, the following variables that are not embedded in the client/browser network service request:
Recommendations per Algorithm
In some embodiments, with multiple recommendation algorithms executing at the same time an allotted number of recommendations can be assigned per algorithm. This will add up for all algorithms to a number equal to or greater than the number of recommendations requested, where specifying a larger number of recommendations per algorithm reduces the likelihood of additional batch algorithm requests being required and provides a wider selection of content to analyze for high quality recommendations, but a larger number of recommendations per algorithm also increases the time of results to be returned from the first batch of requests, as will be readily understood by the skilled person.
Priority Domains
In at least one embodiment, when multiple content domains are specified for results performance profiling are conducted for results from recommendation algorithms and a pairing down of domains based on the ones selected most within a user's persona grouping are given priority and the remainder are omitted if results are taking excessively long (e.g. a max of 200 ms may be specified for the first set of results and if they take too long then content domains that haven't returned results for the algorithms are omitted).
Time Sensitive State Transitions
If a request is not advancing in the selection pipe at a rate considered adequate to return the request results as fast as needed by a client then it is contemplated that a state transitions can occur. For example, if 500 ms is considered the maximum acceptable response time for a specific client and less than ¼ of the workload is completed at the 150 ms mark then a time sensitive transition would occur.
This can result in any of the following actions: the depth of analysis can be reduced, any part of a recommendation algorithm marked as optional potentially can be omitted, and/or a single recommendation algorithm can generate results instead of requiring multiple algorithms running in parallel

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A predictive recommendation engine for managing online content comprising:
Means for receiving a user request for recommended content, the user request including at least one user criterion;
An algorithm selection module for receiving the user request from the means and generating a recommendation data packet based on the user request;
A recommendation algorithm module in communication with the algorithm selection module the real time analytics module and at least one content database, the recommendation algorithm module comprising at least one recommendation algorithm and an analytics engine, the recommendation algorithm adapted to retrieve at least one content recommendation from the least one content database based on the recommendation data packet:
A results selection module in communication with the module, the results selection module adapted to receive and store the at least one content recommendation, the results selection module adapted to sort the at least one content recommendation to generate a ranked content recommendation list, the results selection module adapted to forward the ranked content recommendation list to the algorithm selection module.
A real time analytics engine in communication with the recommendation algorithm module and the at least one content database, the real time analytics engine comprising at least one shared computational resource required by the recommendation algorithms contained in the recommendation algorithm module.

2. The predictive recommendation engine of claim 1, further comprising a behavioral tracking module in communication with the algorithm selection module, the recommendation algorithm module and the at least one content database, the behavioural tracking module adapted to retrieve behavioural data based on at least one behavioural identifier included in the user request and wherein the recommendation data packet is further based on the behavioural data.

3. The predictive recommendation engine of claim 2 wherein the behavioural data includes content data selected from the group consisting of content taxonomy, date/time of content access and geographic location of content access.

4. The predictive recommendation engine of claim 1 wherein the user request further comprises at least one of a user profile identifier, a content domain identifier, a current content identifier, a content filter, a content recommendation limit and at least one behavioural identifier.

5. The predictive recommendation engine of claim 2 wherein the at least one behavioral identifier further comprises at least one of content selection history, recommendation algorithm preference history, recommendation count request, content restriction request, and predetermined mandatory recommendation algorithm specification.

6. The predictive recommendation engine of claim 3 wherein the at least one behavioral identifier further comprises at least one of content selection history, recommendation algorithm preference history, recommendation count request, content restriction request, and predetermined mandatory recommendation algorithm specification.

7. The predictive recommendation engine of claim 4 wherein the at least one behavioral identifier further comprises at least one of content selection history, recommendation algorithm preference history, recommendation count request, content restriction request, and predetermined mandatory recommendation algorithm specification.

8. The predictive recommendation engine of claim 1 wherein the at least one recommendation algorithm is selected based on at least one of the user request, behavioural data, and content data.

9. A method of managing online content with a predictive recommendation comprising the steps of:
Receiving a user request, the user request including at least one user criterion;
Generating a recommendation data packet based on the user request;
Sending the recommendation data packet to a recommendation algorithm module, the recommendation algorithm module comprising at least one recommendation algorithm and an analytics engine;
Retrieving at least one content recommendation from at least one content database;
Sending the at least one content recommendation to a results selection module;
Organizing the at least one content recommendation to generate a ranked content list;
Sending the ranked content list to the user.

10. The method of claim 9 wherein the user request further comprises at least one behavioural identifier, the method further comprising the step of:
Retrieving behavioural data based on the at least one behavioural identifier and wherein the recommendation data packet is generated based on the behavioural data.

11. The method of claim 10 wherein the behavioural data includes content data selected from the group consisting of content taxonomy, date/time of content access and geographic location of content access.

12. The method of claim 11 wherein the user request further comprises at least one of a user profile identifier, a content domain identifier, a current content identifier, a content filter, a content recommendation limit and at least one behavioural identifier.

13. The method of claim 10 wherein the at least one behavioral identifier further comprises at least one of content selection history, recommendation algorithm preference history, a recommendation count request, a content restriction recommendation, and at least one predetermined mandatory recommendation algorithm.

14. The method of claim 11 wherein the at least one behavioral identifier further comprises at least one of content selection history, recommendation algorithm preference history, a recommendation count request, a content restriction recommendation, and at least one predetermined mandatory recommendation algorithm.

15. The method of claim 12 wherein the at least one behavioral identifier further comprises at least one of content selection history, recommendation algorithm preference history, a recommendation count request, a content restriction recommendation, and at least one predetermined mandatory recommendation algorithm.

16. The method of claim 10 wherein the at least one recommendation algorithm is selected based on at least one of the user request, behavioural data, and content data.
